(19) United States
(12) Patent Application Publication
(10) Pub. No.: US 2025/0384409 A1
(43) Pub. Date: Dec. 18, 2025

(54) Calculation system for calculating quantities of materials required for repairing returned products

(71) Applicant: InnoLux Corporation, Miao-Li County (TW)

(72) Inventors: Swee Wei Law, Miao-Li County (TW); Hsiang-Ying Chen, Miao-Li County (TW); Chiu-Ching Yang, Miao-Li County (TW); Phuong Thi Diem Pham, Miao-Li County (TW)

(73) Assignee: InnoLux Corporation, Miao-Li County (TW)

(21) Appl. No.: 19/208,572

(22) Filed: May 14, 2025

(30) Foreign Application Priority Data
Jun. 18, 2024 (CN) 202410782786.0

(51) Int. Cl. G06Q 10/20; G06Q 30/0202

(52) U.S. Cl. CPC G06Q 10/20; G06Q 30/0202

(57) ABSTRACT

A calculation system has a receiving unit, a calculation unit, a determination unit, and an output unit. The receiving unit of the calculation system is used to receive data of historically returned products. The calculation unit of the calculation system is used to calculate the number of each returned product in the next time period based on the data of the historically returned products. The determination unit of the calculation system is used to select the returned products with repair benefits in the next time period, and to calculate the quantity of each material required for repairing the returned products with repair benefits in the next time period, so as to generate data of the quantity of each material. The output unit of the calculation system is used to output the data of the quantity of each material.

### BACKGROUND OF THE DISCLOSURE

### 1. Field of the Disclosure

The present disclosure relates to a calculation system, particularly a calculation system for calculating the quantities of materials required for repairing returned products based on data of historical returned products.

### 2. Description of the Prior Art

Manufacturers generally provide after-sales services for their products, which include the repair of defective products or the return of new products. However, the occurrence of defective products and missed inspections are difficult to avoid. Additionally, if the manufacturer's clients are spread globally, the manufacturer faces varying return demands from clients due to international influences, soaring logistics costs, and differences in repair labor costs across countries. Furthermore, the outbreak of COVID-19 in 2021, along with the surge in demand for panels due to remote work and home schooling, and the Suez Canal blockage incident in the same year, necessitated the manufacturer to return new or repaired products within agreed deadlines to meet client agreements. This affects the quarterly business review (QBR), and clients may also request refunds or compensation for losses. Moreover, excessive stock of finished materials at maintenance centers significantly increases storage costs and the value of obsolete products. Conversely, insufficient stock at maintenance centers can lead to urgent transportation and decreased client satisfaction. Therefore, managing spare parts and materials is a crucial challenge that manufacturers must address.

### SUMMARY OF THE DISCLOSURE

According to some embodiments, the present disclosure provides a calculation system for calculating quantities of materials required for repairing returned products. The calculation system comprises a receiving unit, a calculation unit, a determination unit, and an output unit. The receiving unit is configured to receive data of historical returned products. The calculation unit is configured to calculate a quantity of each returned product in a next time period based on the data of historical returned products. The determination unit is configured to select returned products with repair benefits in the next time period by filtering out returned products without repair benefits, and calculate a quantity of each material required for repairing the returned products with repair benefits in the next time period, thereby generating corresponding data of the quantity of the each material required for repairing the returned products with repair benefits in the next time period. The output unit is configured to output the corresponding data.

According to some embodiments, the present disclosure provides a calculation system for calculating quantities of materials required for repairing returned products. The calculation system comprises a receiving unit, a calculation unit, a determination unit, and an output unit. The receiving unit is configured to receive data of historical returned products. The calculation unit is configured to calculate a quantity of each returned product in a next time period based on the data of historical returned products. The determination unit is configured to select returned products with repair benefits in the next time period by filtering out returned products without repair benefits, and calculate a quantity of each material required for repairing the returned products with repair benefits in the next time period, thereby generating corresponding data of the quantity of the each material required for repairing the returned products with repair benefits in the next time period. The output unit is configured to output the corresponding data to a presentation unit, allowing the presentation unit to physically present the corresponding data.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic diagram illustrating the usage scenario of a calculation system according to the present disclosure.

FIG. 2 is a functional block diagram of an embodiment of the calculation system according to the present disclosure.

FIG. 3 is a flowchart of the calculation system in FIG. 2, calculating the quantities of materials required for repairing the returned products.

### DETAILED DESCRIPTION

The present disclosure can be understood by referring to the following detailed description in conjunction with the accompanying drawings. It should be noted that for the ease of understanding and simplicity of the drawings, many of the figures in the disclosure only depict parts of the electronic device, and the specific elements in the drawings are not drawn to actual scale. Additionally, the quantities and sizes of the elements in the drawings are for illustration purposes only and are not intended to limit the scope of the disclosure.

The entire disclosure and the appended claims use certain terms to refer to specific elements. Those skilled in the art should understand that manufacturers of electronic equipment may use different names for the same elements. This document is not intended to distinguish between elements that have the same function but different names.

In the following description and the claims, the terms “comprise,” “contain,” “have,” and similar terms are open-ended terms and should be interpreted to mean “including but not limited to.” Therefore, when the disclosure uses terms such as “comprise,” “contain,” and/or “have,” it specifies the presence of corresponding features, regions, steps, operations, and/or components but does not exclude the presence of one or more corresponding features, regions, steps, operations, and/or components.

Directional terms mentioned herein, such as “top,” “bottom,” “front,” “back,” “left,” “right,” etc., are merely references to the direction of the drawings. Therefore, the directional terms are used for illustration, not limitation, of the disclosure. In the drawings, the figures illustrate the typical features of methods, structures, and/or materials used in specific embodiments. However, these figures should not be construed as defining or limiting the scope or nature of the embodiments. For example, for clarity, the relative sizes, thicknesses, and positions of each layer, region, and/or structure may be reduced or enlarged.

When a corresponding component (e.g., a layer or region) is referred to as “on another component,” it can be directly on the other component, or there may be other components between them. On the other hand, when a component is referred to as “directly on another component,” there are no other components between them. Additionally, when one component is described as “on another component,” there is an upper and lower relationship between them in the vertical direction. This component may be above or below another component, depending on the orientation of the device.

It should be understood that when a component or layer is referred to as “connected to” another component or layer, it can be directly connected to that other component or layer, or there may be intervening components or layers between them. When a component is referred to as “directly connected to” another component or layer, there are no intervening components or layers between them. Additionally, when a component is described as “coupled to another component (or its variant),” it can be electrically directly connected to that other component, or indirectly connected (e.g., electrically connected) to that other component through one or more components.

In the disclosure, when a component is “disconnected” from another component, electrical signals cannot flow between the two components at the specified time.

The term “approximately” or “about” is generally interpreted to mean within a range of ±10% of the given value or within ±5%, ±3%, ±2%, ±1%, or ±0.5% of the given value.

The ordinal numbers used in the description and the claims, such as “first,” “second,” etc., modify elements and do not imply that the elements have any prior ordinality, nor do they imply any particular sequence or manufacturing order of the elements. These ordinal numbers are used solely to differentiate elements with a given name from other elements with the same name. The terms used in the claims and the description may not be the same, meaning that the first element in the description may be the second element in the claims.

It should be noted that the features of the different embodiments mentioned below can be replaced, rearranged, or mixed with each other to form other embodiments without departing from the spirit of the disclosure. As long as the features of each embodiment do not violate or conflict with the invention's spirit of the disclosure, they can be freely mixed and matched.

In the disclosure, electronic devices may include display devices, lighting devices, antenna devices, sensing devices, splicing devices, or any combination thereof, without limitation. Display devices can be non-self-luminous or self-luminous and can be color or monochrome displays depending on the need. Antenna devices can be liquid crystal or non-liquid crystal, sensing devices can sense capacitance, light, heat, or ultrasound, and splicing devices can be display or antenna splicing devices, without limitation. Electronic devices may include electronic components, which can include passive and active components such as capacitors, resistors, inductors, diodes, transistors, etc. Diodes can include light-emitting diodes (LED) or photodiodes. Light-emitting diodes can include organic light-emitting diodes (OLED), mini light-emitting diodes (mini LED), micro light-emitting diodes (micro LED), or quantum dot light-emitting diodes (quantum dot LED), without limitation. Transistors can include top-gate thin-film transistors, bottom-gate thin-film transistors, or dual-gate thin-film transistors, without limitation. Electronic devices can also include fluorescence materials, phosphor materials, quantum dot (QD) materials, or other suitable materials as needed, without limitation. Electronic devices can have drive systems, control systems, light source systems, and other peripheral systems to support the devices and components within the electronic devices.

It should be noted that the technical features in the different embodiments described below can be replaced, rearranged, or mixed with each other to form other systems, electronic devices, and/or methods without departing from the spirit of the disclosure.

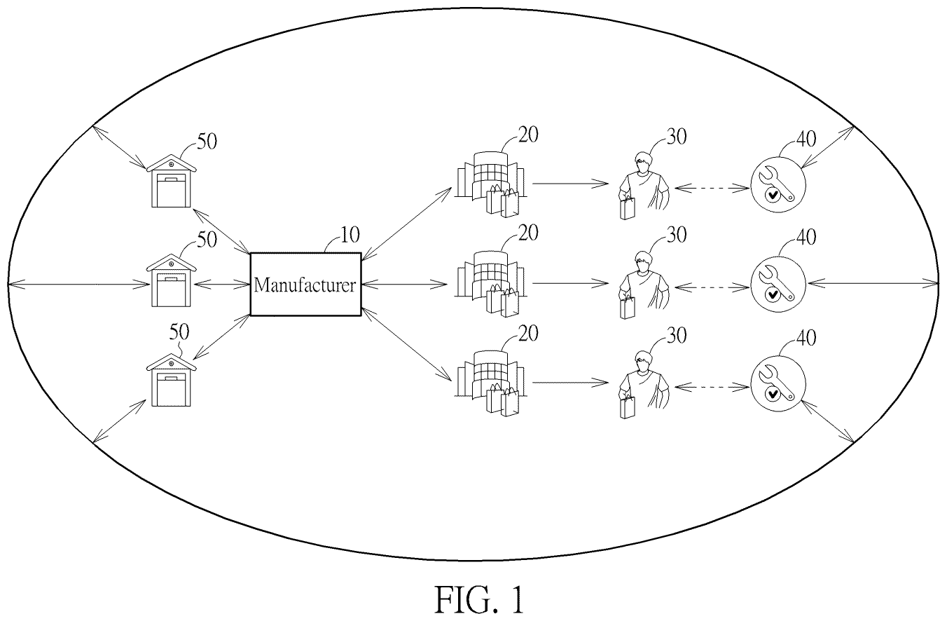

Please refer to FIG. 1, which is a schematic diagram illustrating the usage scenario of a calculation system according to the present disclosure. A manufacturer 10 of electronic devices processes its manufactured products into various types of goods for sale. For example, the manufactured display panels are processed into televisions, tablets, mobile phones, and other value-added products based on displays, and sold to sales centers 20 worldwide. The sales centers 20 then sell the products to clients 30. If a client 30 encounters a problem with a product, the client 30 returns the product to a service station 40. The service station 40 then determines whether the problem with the product was caused by the client 30 or is a product defect. If the problem is determined to be caused by the client 30, the service station 40 will quote a repair price to the client 30. If the client 30 does not repair the product for any reason, the service station 40 returns the product to the client 30. If the problem is due to a product defect, the product is sent to a repair center 50 for repair. In order to save inventory costs and/or emergency transportation costs, the manufacturer 10 will send repair materials to the various repair centers 50 as early as possible, so that the repair centers 50 can promptly return the repaired products to the clients 30 to improve the satisfaction of the clients 30.

The ability of the manufacturer 10 to promptly return new or repaired products to the clients 30 is influenced by the following factors:

(1) Estimation of the quantities of returned products: How to effectively allocate products to each sales center 20 and each maintenance center 50 has always been a challenge for the manufacturer 10. If too many products are allocated to the sales centers 20 and the maintenance centers 50, it will take a longer time to sell them, and unsold products will incur inventory costs. Conversely, if too few products are allocated, the sales centers 20 and the maintenance centers 50 will not be able to ship products to the clients 30 in a timely manner, leading to decreased client satisfaction and affecting the reputation of the manufacturer 10. Therefore, to address these challenges, the disclosure provides a calculation system that automatically collects the necessary data from databases (such as shipment data, order information, and historical data of returned products). The disclosed calculation system can analyze the trend of the quantities of returned products received by different maintenance centers 50 in the past and use deep learning to process historical data to calculate the possible quantity of returned products at different future points in time for each maintenance center 50. The disclosed calculation system can automatically learn features through deep learning and identify the key factors affecting the quantities of returned products. The term “returned products” refers to products returned by the clients 30 through the service stations 40 or the sales centers 20 to the maintenance centers 50 or the manufacturer 10 for replacement or repair.

(2) Evaluation of Repair Benefits: Based on past repair experience, the calculation system disclosed herein can assess whether each maintenance center 50 has the capability to successfully repair returned products and generate profit. Repair benefits analysis covers a wide range, including the repair skills of personnel, cost of repair materials, labor costs, and product prices. The criterion for determining whether repairing defective products is beneficial to the company is whether the product's selling price is greater than the repair cost. If the selling price is greater than the repair cost, it brings positive benefits to the manufacturer 10, who tends to repair defective products. Conversely, if the selling price is less than the repair cost, it brings negative benefits to the manufacturer 10, who tends to avoid repairs or scrap the product. The repair cost mainly comprises material cost and labor cost. To make the evaluation of repair benefits more efficient and increase the reliability of the results, the calculation system disclosed herein can evaluate past repair records based on product classification and the dimensions that the clients 30 care about. By comparing the cost of materials used in repairs and the charging standards of each maintenance center 50, the system calculates repair costs under different dimensions. By comparing the selling price of the product with the repair cost, it determines whether to repair defective products in the future. During the evaluation of repair benefits, the dimensions that the clients 30 care about might be too detailed, leading to insufficient data. The calculation system disclosed herein can use categorical clustering algorithms to classify similar products, enhancing the credibility of the evaluation results of repair benefits.

(3) Prediction of Repair Materials: Whether the repair materials stocked at the maintenance centers 50 are sufficient to avoid waiting times for materials. The usage of materials varies across different maintenance centers 50, different products, and different models. Some materials are frequently used, while others may only be recorded as used every few months. The calculation system disclosed herein can categorize data into the following four types: Unstable, Wavy, Smooth, and Intermittent, based on the variation in material demand and the average usage interval over several months (e.g., 18 months, but not limited thereto). The calculation system disclosed herein can improve inventory management strategies, reduce inventory costs, and ensure the stability of supply for materials needed for repair or replacement through its predictive model.

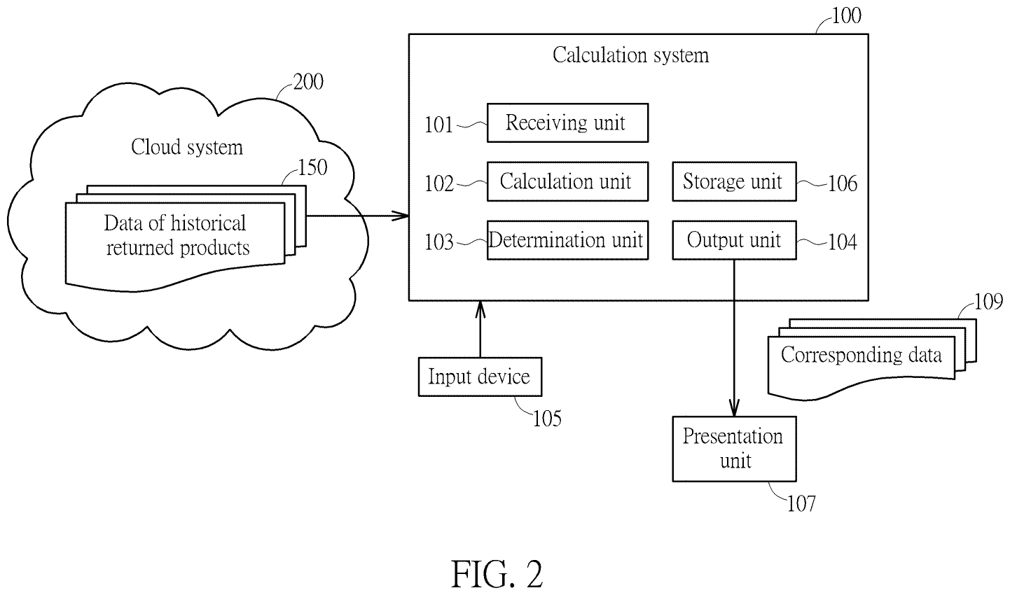

To meet the aforementioned three aspects, the disclosure provides a calculation system. Please refer to FIG. 2, which is a functional block diagram of an embodiment of the calculation system 100 according to the present disclosure. The calculation system 100 is used to calculate the quantities of materials required for repairing the returned products at each maintenance center 50. The calculation system 100 may comprise a receiving unit 101, a calculation unit 102, a determination unit 103, and an output unit 104. The receiving unit 101 is used to receive data of historical returned products 150. The calculation unit 102 is used to calculate the quantity of each returned product for the next time period at each maintenance center 50 based on the data of historical returned products 150. The time period is usually one month, but the disclosure is not limited thereto. In other embodiments of the disclosure, a time period can be one day, one week (seven days), or other durations. If the time period is one month, the calculation unit 102 calculates the quantity of each returned product for the next month at each maintenance center 50. The determination unit 103 is used to select the returned products with repair benefits for the next time period and calculate the quantities of materials required for repairing these returned products to generate corresponding data 109 of the quantities of the quantity of the materials required for repairing these returned products. The corresponding data 109 records the quantities of required materials as calculated by the determination unit 103. The output unit 104 is used to output the corresponding data 109. The receiving unit 101 may comprise, but is not limited to, a Universal Serial Bus (USB), Peripheral Component Interconnect Express (PCI-E), RJ45 network interface, optical fiber network interface, coaxial cable network interface, modem, Wi-Fi module, Bluetooth module, Zigbee module, Worldwide Interoperability for Microwave Access (WiMAX) module, 4th generation (4G) mobile communication module, or 5th generation (5G) mobile communication module. The calculation unit 102 and the determination unit 103 may each be a processor or a Central Processing Unit (CPU), but the disclosure is not limited thereto. In another embodiment, the calculation unit 102 and the determination unit 103 can be integrated into the same integrated circuit (e.g., the same processor). The output unit 104 may comprise, but is not limited to, a Universal Serial Bus (USB), Peripheral Component Interconnect Express (PCI-E), graphics card interface (such as VGA, DVI, HDMI, or DisplayPort interface), and printer interface.

In one embodiment of the disclosure, the calculation system 100 can also receive data and/or instructions entered by the user through an input device 105 via the receiving unit 101, enabling the calculation system 100 to perform corresponding operations based on the data and/or instructions entered by the user through the input device 105. The input device 105 can be, but is not limited to, a keyboard, mouse, or barcode scanner.

In one embodiment of the disclosure, the calculation system 100 can also comprise a storage unit 106 for storing data received by the receiving unit 101, data generated by the calculation unit 102 during the calculation process, and/or the corresponding data 109 output by the output unit 104. The storage unit 106 can be, but is not limited to, dynamic random-access memory (DRAM), static random-access memory (SRAM), flash memory, floppy disks, hard disks, optical discs, USB drives, tapes, or combinations thereof. In one embodiment, the calculation unit 102 can access and execute programs stored in the storage unit 106 to achieve the functions of the calculation system 100.

In one embodiment of the disclosure, the calculation system 100 can also physically present the corresponding data 109 output by the output unit 104 through a presentation unit 107. The presentation unit 107 can comprise a display device as needed to display the corresponding data 109. The display device may comprise but not limited to non-self-luminous or self-luminous displays, and can be a color or monochrome display depending on the needs. In another embodiment, the presentation unit 107 can comprise a printer to print out the corresponding data 109, allowing users to visually understand the information, but the disclosure is not limited thereto.

In one embodiment of the disclosure, the receiving unit 101 of the calculation system 100 can also receive data of historical returned products 150 needed by the calculation unit 102 from a cloud system 200 through the network.

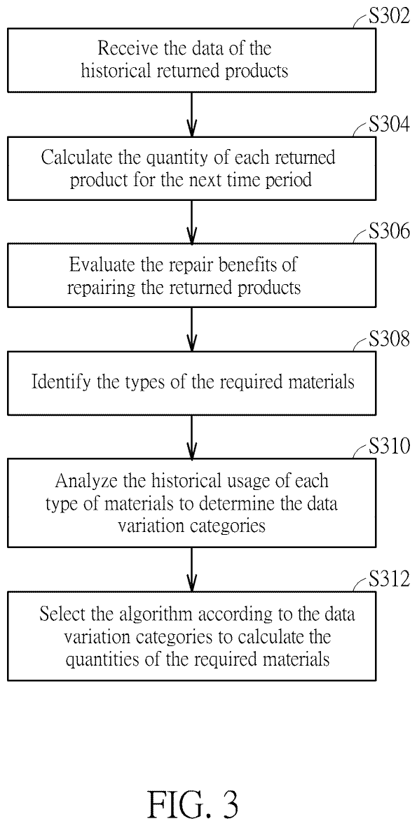

Please refer to FIG. 3, which is a flowchart of the calculation system 100 in FIG. 2, calculating the quantities of materials required for repairing the returned products. In step S302, the calculation system 100 receives data of historical returned products 150 via the receiving unit 101. In step S304, the calculation unit 102 calculates the quantity of each returned product for the next time period at each maintenance center 50 based on the data of historical returned products 150. In step S306, the determination unit 103 evaluates and selects the returned products with repair benefits for the next time period. In step S308, the determination unit 103 identifies the types of the materials and groups the materials required for repairing the returned products in the next time period. In step S310, the determination unit 103 analyzes the historical usage of each type of the materials to determine the data variation categories. In step S312, the determination unit 103 selects the algorithm based on the data variation categories to calculate the quantities of required materials. Further explanations of these steps are provided below.

The following explains the “Estimation of the quantities of returned products” among the aforementioned three aspects. The calculation unit 102 of the calculation system 100 can process the data of historical returned products 150 through deep learning to calculate the possible quantity of each returned product at each maintenance center 50 in the future (i.e., the aforementioned step S304). The deep learning methods used by the calculation unit 102 can comprise but are not limited to extreme Gradient Boosting (XGBoost), Long Short-Term Memory (LSTM), and Transformer models. XGBoost is a gradient boosting algorithm, which is also an ensemble method based on decision trees. Long Short-Term Memory (LSTM) is a recurrent neural network specifically designed to handle sequence data. The Transformer model is a method used in natural language processing, suitable for various types of sequence data. The general computational steps for these three deep learning methods can be explained as follows:
1.1. Based on the data of historical returned products 150, list the historical quantity X of each returned product;
1.2. Adjust parameters using the algorithm (XGBoost/LSTM/Transformer);
1.3. Establish new prediction results;
1.4. Repeat steps 1.2 to 1.3 until iterative calculation is completed; and
1.5. Calculate the quantity Y of each returned product for the next time period;
where Y=f (X).

The historical quantity X of each returned product is represented as:

$$X = [ \begin{matrix}{x}_{1 , 1} & ⋯ & {x}_{1 , p} \\ ⋮ & ⋱ & ⋮ \\ {x}_{n , 1} & ⋯ & {x}_{n , p}\end{matrix} ]$$

where n represents the number of groups of returned products, and p represents the number of features in the data of historical returned products 150.

Further explanations will be provided through examples. Please refer to Table 1 below. Here, assume the next month is month N, the current month is month N−1, and the previous month is month N−2, and so on.

TABLE 1

| | | | | The | The | The | | The |
|---|---|---|---|---|---|---|---|---|
| | | | | quantities | quantities | quantities | | quantities |
| | | | | of | of | of | | of |
| | | | | returned | returned | returned | | returned |
| | | | | products | products | products | | products |
| | | | | in | in | in | | in |
| | | | | month | month | month | | month |
| GID | RID | APP | NAME | (N-1) | (N-2) | (N-3) | . . . | (N-18) |
| 1 | AC | NB | GT01 | 84 | 22 | 78 | . . . | 33 |
| 2 | AC | MNT | GT02 | 20 | 12 | 54 | | 52 |
| 3 | AC | MNT | GT01 | 52 | 35 | 45 | | 35 |
| 4 | AC | MNT | GT01 | 910 | 78 | 23 | | 16 |
| 5 | AC | MNT | GT02 | 785 | 56 | 15 | | 45 |
| 6 | AC | MNT | GT03 | 12 | 45 | 44 | | 88 |

Where GID is the group identifier, RID is the identifier for each maintenance center 50, APP is the product application, and NAME is the product or model name. Different combinations of (RID, APP, NAME) correspond to different GIDs. Additionally, since the strings in Table 1 (e.g., RID, APP, NAME) cannot be directly used for computation, the calculation unit 102 can convert the strings in Table 1 into numbers based on an encoding principle, forming Table 2 below. For example, the encoding principle used by the calculation unit 102 for APP could be: when APP=NB (notebook), it is replaced with the number 0; and when APP=MNT (monitor), it is replaced with the number 1; and so on. Alternatively, when APP=NB, it is replaced with the number 1; and when APP=MNT, it is replaced with the number 0.

TABLE 2

| | | | | The | The | The | | The |
|---|---|---|---|---|---|---|---|---|
| | | | | quantities | quantities | quantities | | quantities |
| | | | | of | of | of | | of |
| | | | | returned | returned | returned | | returned |
| | | | | products | products | products | | products |
| | | | | in | in | in | | in |
| | | | | month | month | month | | month |
| GID | RID | APP | NAME | (N-1) | (N-2) | (N-3) | . . . | (N-18) |
| 1 | 1 | 0 | 0 | 84 | 22 | 78 | . . . | 33 |
| 2 | 1 | 1 | 1 | 20 | 12 | 54 | | 52 |
| 3 | 1 | 1 | 0 | 52 | 35 | 45 | | 35 |
| 4 | 1 | 1 | 0 | 910 | 78 | 23 | | 16 |
| 5 | 1 | 1 | 1 | 785 | 56 | 15 | | 45 |
| 6 | 1 | 1 | 2 | 12 | 45 | 44 | | 88 |

After obtaining Table 2 through the encoding principles, the calculation unit 102 can derive the aforementioned X and Y based on Table 2:

$$X = {[ \begin{matrix}1 & 0 & 0 & 84 & 22 & 78 & ⋯ & 33 \\ ⋮ & & & & ⋱ & & & ⋮ \\ 1 & 1 & 2 & 12 & 45 & 44 & ⋯ & 88\end{matrix} ]}_{6 * 21}$$

$$Y = [ \begin{matrix}{y}_{1} \\ … \\ {y}_{6}\end{matrix} ] = {[ \begin{matrix}14 \\ … \\ 76\end{matrix} ]}_{6 * 1}$$

where y1 is the predicted value for group 1 (GID=1) for the next month (i.e., month N) calculated by the model; y2 is the predicted value for group 2 (GID=2) for the next month (i.e., month N), and so on. XGBoost, Transformer, and LSTM are common models in the fields of machine learning and deep learning. They are widely used for handling various types of data and problems. By using the Python programming language and its related packages, the calculation unit 102 can effectively predict and calculate the quantity of each returned product for the next time period (such as the next month) using the dataset X.

In Table 3 below, the three columns on the far right show the quantities of returned products for each group as predicted by the calculation unit 102 using the XGBoost/LSTM/Transformer algorithms, respectively.

TABLE 3

| GID | RID | APP | NAME | XGBoost | LSTM | Transformer |
|---|---|---|---|---|---|---|
| 1 | AC | NB | GT01 | 0 | 32 | 7 |
| 2 | AC | MNT | GT02 | 3 | 5 | 0 |
| 3 | AC | MNT | GT01 | 41 | 39 | 49 |
| 4 | AC | MNT | GT01 | 0 | 2 | 0 |
| 5 | AC | MNT | GT02 | 29 | 17 | 12 |
| 6 | AC | MNT | GT03 | 23 | 13 | 25 |

The following explains the “Evaluation of Repair Benefits” among the aforementioned three aspects. The determination unit 103 of the calculation system 100 can select the returned products with repair benefits for the next time period (i.e., the aforementioned step S306). To enhance the credibility of the evaluation results of repair benefits, the determination unit 103 can classify the returned products for the next time period based on K-Means or K-Modes clustering methods in step S306. Furthermore, the determination unit 103 can classify the returned products based on their features (e.g., maintenance center, product type, size, defect condition) using K-Means or K-Modes clustering methods. By classifying the returned products, the system can avoid insufficient data due to overly detailed analysis dimensions. The following further illustrates how the determination unit 103 evaluates repair benefits using display panels as an example. Please refer to Table 4 below, where PID is the identifier for the display panel, RID is the identifier for each maintenance center 50, APP is the product application, NAME is the model name, PDID is the product name, SR is the size range of the display panel, and DTP is the defect type causing the display panel malfunction.

TABLE 4

| PID | RID | APP | NAME | PDID | SR | DTP |
|---|---|---|---|---|---|---|
| 1 | AC | NB | GT01 | GG01 | ″5.1-7 | BL |
| 2 | AC | MNT | GT02 | GG02 | ″5.1-7 | EE |
| 3 | AC | MNT | GT01 | GG01 | ″5.1-7 | POL |
| 4 | AC | MNT | GT01 | GG01 | ″5.1-7 | EE |
| 5 | AC | MNT | GT02 | GG02 | ″5.1-7 | BL |
| 6 | AC | MNT | GT03 | GG03 | 11.1-13 | EE |

Since the strings in Table 4 (e.g., RID, APP, NAME, PDID, SR, DTP) cannot be directly used for computation, the determination unit 103 can convert these strings into numbers based on encoding principles, thereby obtaining Table 5 below.

TABLE 5

| PID | RID | APP | NAME | PDID | SR | DTP |
|---|---|---|---|---|---|---|
| 1 | 0 | 0 | 0 | 0 | 0 | 0 |
| 2 | 0 | 1 | 1 | 1 | 0 | 1 |
| 3 | 0 | 1 | 0 | 0 | 0 | 2 |
| 4 | 0 | 1 | 0 | 0 | 0 | 1 |
| 5 | 0 | 1 | 1 | 1 | 0 | 0 |
| 6 | 0 | 1 | 2 | 2 | 1 | 1 |

Regardless of whether the determination unit 103 uses the K-Means clustering method or the K-Modes clustering method to classify the returned products for the next time period, the following steps are taken:
2.1. Set k, which can be determined using the Elbow Method;
2.2. Randomly select k centroids;
2.3. Use a distance formula to calculate the distance between each display panel and the centroid cⱼ, and classify each panel to the nearest centroid;
2.4. Update the centroids cⱼ;
2.5. Repeat steps 2.3 to 2.4 until convergence; and
2.6. Calculate and record the total cost, which is the sum of the distances between each sample xᵢ and its centroid cⱼ for each group.

Using the K-Means clustering method as an example, when the determination unit 103 classifies the data in Table 5 using the K-Means clustering method, the steps 2.1 to 2.6 can be further explained as follows:

2.1. The determination unit 103 sets k to 2.

2.2. The determination unit 103 randomly selects the display panels with PID 3 and PID 5 as the centroids, denoted as c₃ and c₅, respectively.

2.3. The determination unit 103 uses a distance formula to calculate the distance between each display panel and the centroids c₃ and c₅. For example, the distances between the display panel with PID 1 and the centroids c₃ and c₅ are denoted as D (x₁, c₃) and D (x₁, c₅), respectively.

$$\begin{matrix}D ( {x}_{1} , {c}_{3} ) = \sqrt{{\sum }_{k = 1}^{n} {( {x}_{1 k} - {c}_{3 k} )}^{2}} \\ = \sqrt{{( 0 - 0 )}^{2} + {( 0 - 1 )}^{2} + {( 0 - 0 )}^{2} + {( 0 - 0 )}^{2} + {( 0 - 0 )}^{2} + {( 0 - 2 )}^{2}} \\ = 2.24\end{matrix}$$

$$\begin{matrix}D ( {x}_{1} , {c}_{5} ) = \sqrt{{\sum }_{k = 1}^{n} {( {x}_{1 k} - {c}_{5 k} )}^{2}} \\ = \sqrt{{( 0 - 0 )}^{2} + {( 0 - 1 )}^{2} + {( 0 - 0 )}^{2} + {( 0 - 0 )}^{2} + {( 0 - 0 )}^{2} + {( 0 - 2 )}^{2}} \\ = 1.7\end{matrix}$$

The calculation results show that the display panel with PID 1 is closer to centroid c₅ than to centroid c₃ (2.24>1.7). Therefore, the determination unit 103 will classify the display panel with PID 1 into the group of c₅. The determination unit 103 will use the same calculation method to calculate the distance between each display panel (excluding the centroids c₃ and c₅) and the centroids c₃ and c₅, then classify each display panel accordingly. Specifically, the display panel with PID 2 is 1.7 units away from centroid c₃ and 1 unit away from centroid c₅, so it is classified in the same category as the display panel with PID 5. The display panel with PID 4 is 1 unit away from centroid c₃ and 1.7 units away from centroid c₅, so it is classified in the same category as the display panel with PID 3. The display panel with PID 6 is 3.2 units away from centroid c₃ and 2 units away from centroid c₅, so it is classified in the same category as the display panel with PID 5.

2.4. Update the centroid: Table 6 illustrates an example where the display panels in the same category as the display panel with PID 5 are considered. The determination unit 103 calculates the average of each sample xᵢ to obtain a new centroid \(c\) as (0, 0.75, 1, 1, 0.25, 0.5).

TABLE 6

| PID | RID | APP | NAME | PDID | SR | DTP |
|---|---|---|---|---|---|---|
| 1 | 0 | 0 | 0 | 0 | 0 | 0 |
| 2 | 0 | 1 | 1 | 1 | 0 | 1 |
| 5 | 0 | 1 | 1 | 1 | 0 | 0 |
| 6 | 0 | 1 | 2 | 2 | 1 | 1 |
| average | 0 | 0.75 | 1 | 1 | 0.25 | 0.5 |

2.5. The determination unit 103 repeats steps 2.2 to 2.4 until convergence, resulting in the display panels with PID 2, 3, and 4 being classified into the same group with centroid c_{g0}, and the display panels with PID 1, 5, and 6 being classified into the same group with centroid c_{g1}. The centroids are c_{g0}=[0, 0.75, 1, 1, 0.25, 0.5] and c_{g1}=[0, 1, 0, 0, 0, 1.5].

2.6. The determination unit 103 calculates and records the total cost, which is the sum of the distances between each sample xᵢ and its centroid cⱼ for each group.

$$Cost = ( {x}_{1} , {c}_{g 0} ) + D ( {x}_{2} , {c}_{g 0} ) + D ( {x}_{5} , {c}_{g 0} ) + D ( {x}_{6} , {c}_{g 0} ) + D ( {x}_{3} , {c}_{g 1} ) + D ( {x}_{4} , {c}_{g 1} ) = 1.695 + 0.612 + 0.612 + 1.695 + 0.5 + 0.5 = 5.614$$

Using the K-Modes clustering method as an example, when the determination unit 103 classifies the data in Table 5 using the K-Modes clustering method, the steps 2.1 to 2.6 can be further explained as follows:

2.1. The determination unit 103 sets k to 2.

2.2. The determination unit 103 randomly selects PID 3 and PID 5 as the centroids, denoted as c₃ and c₅, respectively.

2.3. The determination unit 103 uses a distance formula to calculate the distance between each display panel and the centroids c₃ and c₅. For example, the distances between the display panel with PID 1 and the centroids c₃ and c₅ are denoted as D(x₁,c₃) and D(x₁,c₅), respectively.

$$D ( {x}_{1} , {c}_{3} ) = {\sum }_{k = 1}^{n} I ( {x}_{1 k} \neq {c}_{3 k} ) = 0 + 1 + 0 + 0 + 0 + 1 = 2$$

$$D ( {x}_{1} , {c}_{5} ) = {\sum }_{k = 1}^{n} I ( {x}_{1 k} \neq {c}_{5 k} ) = 0 + 1 + 1 + 1 + 0 + 0 = 3$$

The calculation results show that the display panel with PID 1 is closer to centroid c₃ than to centroid c₅ (2<3). Therefore, the determination unit 103 will classify the display panel with PID 1 into the group of c₃. The determination unit 103 will use the same calculation method to compute the distance between each display panel (excluding centroids c₃ and c₅) and the centroids c₃ and c₅, then classify each display panel accordingly. Specifically, the display panel with PID 2 is 3 units away from centroid c₃ and 1 unit away from centroid c₅, so it is classified in the same category as the display panel with PID 5. The display panel with PID 4 is 1 unit away from centroid c₃ and 3 units away from centroid c₅, so it is classified in the same category as the display panel with PID 3. The display panel with PID 6 is 4 units away from centroid c₃ and 4 units away from centroid c₅, so it is classified in the same category as the display panel with PID 5.

2.4. Update the centroid: Table 7 illustrates an example where the display panels in the same category as the display panel with PID 5 are considered. The determination unit 103 calculates the mode of each feature of each sample xᵢ to obtain a new centroid c as (0, 1, 1, 1, 0, 1).

TABLE 7

| PID | RID | APP | NAME | PDID | SR | DTP |
|---|---|---|---|---|---|---|
| 2 | 0 | 1 | 1 | 1 | 0 | 1 |
| 5 | 0 | 1 | 1 | 1 | 0 | 0 |
| 6 | 0 | 1 | 2 | 2 | 1 | 1 |
| Mode | 0 | 1 | 1 | 1 | 0 | 1 |

2.5. The determination unit 103 repeats steps 2.2 to 2.4 until convergence, resulting in the display panels with PID 2, 5, and 6 being classified into the same group with centroid c_{g0}, and the display panels with PID 1, 3, and 4 being classified into the same group with centroid c_{g1}. The centroids are c_{g0}=[0, 1, 1, 1, 0, 1] and c_{g1}=[0, 1, 0, 0, 0, 1.5].

2.6. The determination unit 103 calculates and records the total cost, which is the sum of the distances between each sample xᵢ and its centroid cⱼ for each group.

$$Cost = D ( {x}_{2} , {c}_{g 0} ) + D ( {x}_{5} , {c}_{g 0} ) \text{} + \text{} D ( {x}_{6} , \text{} {c}_{g 0} + D ( {x}_{1} , {c}_{g 1} ) + D ( {x}_{3} , {c}_{g 1} ) + ( {x}_{4} , {c}_{g 1} ) = 0 + 1 + 3 + 2 + 1 + 1 = 8$$

After the determination unit 103 completes the classification of each returned product, it calculates the corresponding repair benefits for the returned products classified in the same category. The following explanation is provided with Table 8 below:

TABLE 8

| | | | | | | | Material | Labor | Product |
|---|---|---|---|---|---|---|---|---|---|
| PID | RID | APP | NAME | PDID | SF | DTP | Cost | Cost | Price |
| 1 | AC | NB | GT01 | GG01 | ″5.1-7 | BL | 5 | 3 | 10 |
| 2 | AC | MNT | GT02 | GG02 | ″5.1-7 | EE | 2 | 3 | 10 |
| 3 | AC | MNT | GT01 | GG01 | ″5.1-7 | POL | 10 | 3 | 10 |
| 4 | AC | MNT | GT01 | GG01 | ″5.1-7 | EE | 2 | 3 | 10 |
| 5 | AC | MNT | GT02 | GG02 | ″5.1-7 | BL | 5 | 3 | 10 |
| 6 | AC | MNT | GT03 | GG03 | 11.1-13 | EE | 2 | 5 | 20 |

Table 8 is an extension of Table 4 with the addition of the following three columns: Material Cost, Labor Cost, and Product Price. For convenience, assume that the display panels with PID 1 to 6 in Table 8 are classified in the same category. The repair benefits for this category of display panels, calculated by the determination unit 103 through the calculation unit 102, can be expressed by the following mathematical formula:

$$\begin{matrix}Repair benefits = \frac{1}{n} ( {\sum }_{i = 1}^{n} {( Product Price )}_{i} - ( {\sum }_{i = 1}^{n} ( {( Material Cost )}_{i} + {( Labor Cost )}_{i} ) ) \\ = \frac{1}{6} \{ ( 10 + 10 + 10 + 10 + 10 + 10 + 20 ) \\ - [ ( 5 + 3 ) + ( 2 + 3 ) + ( 10 + 3 ) + ( 2 + 3 ) + ( 5 + 3 ) + ( 2 + 5 ) ] \} \\ = \frac{1}{6} * 24 = 4\end{matrix}$$

The above mathematical expression

$$( {\sum }_{i = 1}^{n} ( {( Material Cost )}_{i} + {( Labor Cost )}_{i} )$$

represents the total repair cost of the returned products, while

$$\frac{1}{n} ( ( {\sum }_{i = 1}^{n} ( {( Material Cost )}_{i} + {( Labor Cost )}_{i} ) )$$

is the average repair cost of the returned products. Since the repair benefits equal 4 (i.e., greater than or equal to zero), which is a positive benefit, the determination unit 103 determines that the returned products belong to the display panels in Table 8 that have repair benefits in the next time period. Conversely, if the repair benefits are less than zero, the determination unit 103 determines that the returned products do not have repair benefits.

The following explains the “Prediction of Repair Materials” among the aforementioned three aspects. The determination unit 103 of the calculation system 100 can calculate the quantities of materials required for repairing the returned products with repair benefits for the next time period (such as the next month). Before predicting the repair materials, the determination unit 103 filters out the returned products without repair benefits to select those with repair benefits for the next time period. Assuming the determination unit 103, through the aforementioned evaluation of repair benefits, arrives at the following Table 9:

TABLE 9

| PID | RID | APP | NAME | PDID | SR | DTP | RBF |
|---|---|---|---|---|---|---|---|
| 1 | AC | NB | GT01 | GG01 | ″5.1-7 | BL | Y |
| 2 | AC | MNT | GT02 | GG02 | ″5.1-7 | EE | Y |
| 3 | AC | MNT | GT01 | GG01 | ″5.1-7 | POL | Y |
| 4 | AC | MNT | GT01 | GG01 | ″5.1-7 | EE | N |
| 5 | AC | MNT | GT02 | GG02 | ″5.1-7 | BL | Y |
| 6 | AC | MNT | GT03 | GG03 | 11.1-13 | EE | Y |

Table 9 is an extension of Table 4 with an additional RBF column. If the value in the RBF column is Y, it indicates that the corresponding returned product has repair benefits. If the value is N, it indicates that the corresponding returned product does not have repair benefits. After obtaining Table 9, the determination unit 103 filters out the returned products that do not have repair benefits, to select those with repair benefits for the next time period, thereby obtaining Table 10 below.

TABLE 10

| PID | RID | APP | NAME | PDID | SR | DTP | RBF |
|---|---|---|---|---|---|---|---|
| 1 | AC | NB | GT01 | GG01 | ″5.1-7 | BL | Y |
| 2 | AC | MNT | GT02 | GG02 | ″5.1-7 | EE | Y |
| 3 | AC | MNT | GT01 | GG01 | ″5.1-7 | POL | Y |
| 5 | AC | MNT | GT02 | GG02 | ″5.1-7 | BI | Y |
| 6 | AC | MNT | GT03 | GG03 | 11.1-13 | EE | Y |

Subsequently, the determination unit 103 will expand the required materials for the returned products with repair benefits for the next time period. Taking the returned product with PID equal to 1 from Table 10 as an example, the required materials after expansion can be represented as shown in Table 11 below.

TABLE 11

| PID | RID | APP | NAME | PDID | PTN | RFD | QTY |
|---|---|---|---|---|---|---|---|
| 1 | ACCU | NB | GT01 | GG01 | Bezel | 2021/10/05 | 1 |
| 1 | ACCU | NB | GT01 | GG01 | PCBA | 2021/08/12 | 5 |
| 1 | ACCU | NB | GT01 | GG01 | Backlight | 2021/04/07 | 7 |
| 1 | ACCU | NB | GT01 | GG01 | Backlight | 2021/03/18 | 2 |
| 1 | ACCU | NB | GT01 | GG01 | Backlight | 2021/01/21 | 4 |

In Table 11, PTN represents the material name, RFD represents the repair completion date, and QTY represents the required quantity. The determination unit 103 can categorize data with the same combination of (RID, APP, NAME, PDID, PTN) into the same group. In other words, the determination unit 103 can group the required materials for the returned products in the same category (as in step S308 mentioned above). The materials grouped into the same group can be considered to be of the same type. It is worth noting that the determination unit 103 first classifies the returned products for the next time period in step S306 and then groups the required materials for the same category of returned products in step S308.

Additionally, in the aforementioned step S310, the determination unit 103 can first classify the historical data of returned products 150 based on the coefficient of variation (CV) and the average demand interval (ADI) of each material over multiple months (e.g., 18 months). This classification divides the past usage records of each group into four data variation categories: unstable, wavy, smooth, and intermittent. The coefficient of variation (CV) and the average demand interval (ADI) for each material in each group can be collectively referred to as the “historical demand data for each material.” In one embodiment of the invention, if the square of the coefficient of variation of material demand is greater than or equal to 0.5 and the average demand interval is greater than or equal to 1.32, then the past usage records for each group fall under the wavy category. If the square of the coefficient of variation of material demand is greater than or equal to 0.5 and the average demand interval is less than 1.32, then the past usage records for each group fall under the unstable category. If the square of the coefficient of variation of material demand is less than 0.5 and the average demand interval is greater than or equal to 1.32, then the past usage records for each group fall under the intermittent category. If the square of the coefficient of variation of material demand is less than 0.5 and the average demand interval is less than 1.32, then the past usage records for each group fall under the smooth category. The determination unit 103 can select appropriate algorithms to calculate the quantities of materials based on the past usage records for each group (i.e., the aforementioned step S312). Furthermore, the determination unit 103 can selectively use Croston's model, Recurrent Neural Network (RNN), or Random Forest Regression based on the distribution of the historical usage data for each group to calculate the quantities of materials.

When the historical usage data of materials for each group is classified as unstable, the determination unit 103 can use Recurrent Neural Network (RNN) to calculate the quantities of materials. When the historical usage data is classified as wavy or intermittent, the determination unit 103 can use Croston's model to calculate the quantities of materials. When the historical usage data is classified as smooth, the determination unit 103 can use Random Forest Regression to calculate the quantities of materials. The following explanation is provided with Table 12 below:

TABLE 12

| Year | Jan | Feb | Mar | Apr | May | Jun | Jul | Aug | Sep | Oct | Nov | Dec |
|---|---|---|---|---|---|---|---|---|---|---|---|---|
| 1 | 0 | 2 | 0 | 1 | 0 | 11 | 0 | 0 | 0 | 0 | 2 | 0 |
| 2 | 6 | 3 | 0 | 0 | 0 | 0 | 0 | 7 | 0 | 0 | 0 | 0 |
| 3 | 0 | 0 | 0 | 3 | 1 | 0 | 0 | 1 | 0 | 1 | 0 | 0 |

Table 12 records the demand for a specific material in each month over the previous three consecutive years. “Year” indicates the year, and the columns from “Jan” to “Dec” represent the demand for each month from January to December. If the determination unit 103 chooses to use Croston's model to calculate the material usage, it follows these steps (a1 to a6) to obtain the expected usage data for the material:
a1. List the sequence of values for which there is demand.
a2. Calculate the sequence of intermittent intervals.
a3. Set the values of a and B based on the material situation.
a4. Update the demand values for each step.
a5. Repeat steps a3 to a4 until the last interval.
a6. Calculate the final required quantities of materials.

Through these steps (a1 to a6), the determination unit 103 can determine the material quantity required for the next month, which is 9 units. Since Croston's model is a well-known technique, the above text provides a simple explanation.

If the determination unit 103 chooses to use a Recurrent Neural Network (RNN) to calculate the material usage, it follows these steps (b1 to b5) to obtain the expected usage data for the material:
b1. List all demand sequences.
b2. Update the parameters through neurons.
b3. Establish new prediction results.
b4. Repeat steps b2 to b3 until the last interval.
b5. Calculate the final required material value.

Through these steps (b1 to b5), the determination unit 103 can determine the material quantity required for the next month, which is 6 units. Since the Recurrent Neural Network (RNN) is a well-known technique, the above text provides a simple explanation.

If the determination unit 103 chooses to use Random Forest Regression to calculate the material usage, it follows these steps (c1 to c5) to obtain the expected usage data for the material:
c1. List all demand sequences.
c2. Capture trends through feature engineering.
c3. Build decision trees to predict the next forecast value.
c4. Repeat steps c2 to c3 until the final tree.
c5. Calculate the final required material value.

Through these steps (c1 to c5), the determination unit 103 can determine the material quantity required for the next month, which is 12 units. Since Random Forest Regression is a well-known technique, the above text provides a simple explanation.

After the determination unit 103 completes the prediction of material usage, there may be instances of sudden increases or decreases in material usage. Therefore, the determination unit 103 can collect data on returned products that have been received but not yet repaired and compare it with the historical usage records of materials. If there is a high correlation, the determination unit 103 will adjust the predicted material usage by multiplying the original predicted usage by the corresponding correlation ratio. The specific adjustment principles are as follows:
d1. Use at least 5 time periods (e.g., 5 months) of historical material usage records to calculate the correlation coefficient.
d2. Trigger conditions:
Condition 1: The difference in the number of returned but not yet repaired products between two consecutive time periods (e.g., month N and month (N−1)) is greater than 30; and
Condition 2: 1≥(correlation coefficient)≥0.5.
d3. Adjustment formula:

$$If ( the usage in month N ) > ( the usage in month ( N - 1 ) ) , indicating an increase in usage , the new predicted material usage = original predicted usage \times ( 1 + correlation coefficient ) ;$$

$$If ( the usage in month N ) < ( the usage in month ( N - 1 ) ) , indicating a decrease in usage , the new predicted material usage = original predicted usage \times ( correlation coefficient ) .$$

By using the aforementioned method, the determination unit 103 can effectively reduce the magnitude of the difference in expected usage caused by sudden increases or decreases in material usage, while adjusting the expected usage without significantly changing the original forecast value. Assuming the correlation coefficient is denoted by ρ, the determination unit 103 can calculate the correlation coefficient ρ using the following formula:

$$ρ = \frac{{\sum }_{i = 1 , j = 1}^{n} ( {x}_{i} - {μ}_{x} ) ( {y}_{i} - {μ}_{y} )}{\sqrt{{\sum }_{i = 1}^{n} {( {x}_{i} - {μ}_{x} )}^{2} {\sum }_{j = 1}^{n} {( {y}_{i} - {μ}_{y} )}^{2}}}$$

Where xᵢ represents the expected usage of the materials for returned but not yet repaired products in the i^{th} time period (e.g., the i^{th} month), and yⱼ represents the historical usage of the materials in the j^{th} time period (e.g., the j^{th} month).

The disclosed calculation system in the above embodiments comprehensively considers the three aspects of “estimation of the quantities of returned products,” “evaluation of repair benefits,” and “prediction of repair materials” to calculate the expected quantities of returned products for repair. It evaluates the repair benefits of each returned product and calculates the quantities of materials required, thereby reducing inventory costs and enhancing the overall market competitiveness of the enterprise.

The disclosed embodiments also provide a computer-readable storage medium storing a computer program that can be used to execute the method for calculating the quantities of materials required for repairing returned products as described in the above embodiments.

Furthermore, the disclosed embodiments provide a non-volatile computer-readable storage medium containing one or more program modules. When applied to a device, these program modules enable the device to execute the steps included in any of the embodiments described above.

The aforementioned computer-readable storage medium can be, for example (but not limited to), an electrical, magnetic, optical, electromagnetic, infrared, or semiconductor device or combination thereof. More specific examples of computer-readable storage media can include, but are not limited to, portable computer disks, hard drives, random-access memory (RAM), read-only memory (ROM), erasable programmable read-only memory (EPROM), optical fibers, read-only memory optical disks (CD-ROM), optical storage devices, magnetic storage devices, or any suitable combination of the above.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A calculation system for calculating quantities of materials required for repairing returned products, the calculation system comprising:
a receiving unit for receiving data of historical returned products;
a calculation unit for calculating a quantity of each returned product in a next time period based on the data of historical returned products;
a determination unit for selecting returned products with repair benefits in the next time period by filtering out returned products without repair benefits, and calculating a quantity of each material required for repairing the returned products with repair benefits in the next time period, thereby generating corresponding data of the quantity of the each material required for repairing the returned products with repair benefits in the next time period; and
an output unit for outputting the corresponding data.

2. The calculation system of claim 1, wherein the calculation unit calculates the quantity of each returned product in the next time period based on one of algorithms of extreme Gradient Boosting (XGBoost), Long Short-Term Memory (LSTM), and Transformer.

3. The calculation system of claim 1, wherein the determination unit classifies each returned product in the next time period based on K-Means or K-Modes clustering method.

4. The calculation system of claim 3, wherein the calculation unit is further configured to calculate an average repair cost for returned products classified into the same category in the next time period.

5. The calculation system of claim 3, wherein the determination unit is further configured to group materials required for repairing returned products classified into the same category.

6. The calculation system of claim 5, wherein the determination unit selectively uses one of Croston's model, Recurrent Neural Network (RNN), or Random Forest Regression, based on distribution of data of each group, to calculate the quantities of the materials required for repairing the returned products with repair benefits in the next time period, to generate the corresponding data.

7. The calculation system of claim 5, wherein the data of each group includes historical demand data of the each material, and the historical demand data of the each material includes average demand interval (ADI) and coefficient of variation (CV) of the each material.

8. The calculation system of claim 1, wherein the determination unit calculates the quantity of the each material required for repairing the returned products with repair benefits in the next time period based on a correlation coefficient.

9. The calculation system of claim 1, wherein the receiving unit receives the data of historical returned products from a cloud system through a network.

10. The calculation system of claim 1, wherein the output unit transmits the corresponding data to a presentation unit.

11. A calculation system for calculating quantities of materials required for repairing returned products, the calculation system comprising:
a receiving unit for receiving data of historical returned products;
a calculation unit for calculating a quantity of each returned product in a next time period based on the data of historical returned products;
a determination unit for selecting returned products with repair benefits in the next time period by filtering out returned products without repair benefits, and calculating a quantity of each material required for repairing the returned products with repair benefits in the next time period, thereby generating corresponding data of the quantity of the each material required for repairing the returned products with repair benefits in the next time period; and
an output unit for outputting the corresponding data to a presentation unit, allowing the presentation unit to physically present the corresponding data.

12. The calculation system of claim 11, wherein the calculation unit calculates the quantity of each returned product in the next time period based on one of algorithms of extreme Gradient Boosting (XGBoost), Long Short-Term Memory (LSTM), and Transformer.

13. The calculation system of claim 11, wherein the determination unit classifies each returned product in the next time period based on K-Means or K-Modes clustering method.

14. The calculation system of claim 13, wherein the calculation unit is further configured to calculate an average repair cost for returned products classified into the same category in the next time period.

15. The calculation system of claim 13, wherein the determination unit is further configured to group materials required for repairing returned products classified into the same category.

16. The calculation system of claim 15, wherein the determination unit selectively uses one of Croston's model, Recurrent Neural Network (RNN), or Random Forest Regression, based on distribution of data of each group, to calculate the quantities of the materials required for repairing the returned products with repair benefits in the next time period, to generate the corresponding data.

17. The calculation system of claim 15, wherein the data of each group includes historical demand data of the each material, and the historical demand data of the each material includes average demand interval (ADI) and coefficient of variation (CV) of the each material.

18. The calculation system of claim 11, wherein the determination unit calculates the quantity of the each material required for repairing the returned products with repair benefits in the next time period based on a correlation coefficient.

19. The calculation system of claim 11, wherein the receiving unit receives the data of historical returned products from a cloud system through a network.

20. The calculation system of claim 11, wherein the presentation unit comprises a display configured to display the corresponding data or a printer to print out the corresponding data.
